(19) United States
(12) Patent Application Publication
(10) Pub. No.: US 2024/0217652 A1
(43) Pub. Date: Jul. 4, 2024

(54) VTOL BOX-WING MULTIROTOR AERIAL VEHICLE

(71) Applicant: Xi Wang, Saint-Laurent (CA)

(72) Inventor: Xi Wang, Saint-Laurent (CA)

(21) Appl. No.: 18/091,359

(22) Filed: Dec. 29, 2022

(51) Int. Cl. B64C 29/00; B64C 1/00; B64C 3/16; B64C 9/00; B64C 11/48; B64C 27/22

(52) U.S. Cl. CPC B64C 29/0008; B64C 1/00; B64C 3/16; B64C 9/00; B64C 11/48; B64C 27/22; B64C 2009/005

(57) ABSTRACT

A VTOL (vertical take-off and landing) box-wing aerial vehicle with multirotor to provide VTOL flight includes a detachable cabin, centered fuselage, a pair of first wings extending outward from the upper portion of the fuselage and a pair of second wings extending outwardly and from the lower portion of the fuselage. The first and second wings are spaced apart longitudinally and vertically. The pylon joints the first wing and second wing at the tip to form the box-wing. The pylon includes heading control rudder. Secured to the wing or pylon or both wing and pylon, a fixed rotor boom extending longitudinally to support a plurality of lift rotors for VTOL flight. In one configuration, the rotor boom is pivotable. Finally, the fuselage mounted push rotor propels the vehicle forward to generate lift from the wings. Furthermore, the wings are equipped with elevators and ailerons for flight control.

### CROSS-REFERENCE TO RELATED APPLICATIONS

U.S. PATENT DOCUMENTS

| | | | |
|---|---|---|---|
| 3,053,480 | Oct. 6, 1959 | Edward G. | 244 |
| | | Vanderlip | |
| 3,834,654 | Sep. 10, 1974 | Luis R. Miranda | 244/14 |
| 5,503,352 | Apr. 2, 1996 | Vladimir S. Eger | 244/45 |
| 9,004,396 B1 | Apr. 14, 2015 | Youenn Colin | B64C27/08 |
| 2018/0305005 | Oct. 25, 2018 | Robert W. Park | B64C 27/26 |
| | | | B64C 27/30 |
| | | | B64C 29/0025 |
| | | | B64D 27/24 |
| 10,364,036 B6 | Jul. 30, 2019 | James Joseph | B64C 29/02 |
| | | Tigh | B64C 29/00 |
| | | | B64C 29/005 |
| 2020/0317353 A1 | Oct. 8, 2020 | JoeBen Bevirt | B64D 27/24 |
| | | | B64C 29/0033 |
| | | | B64C 39/068 |
| | | | B64C 29/0033 |
| | | | B64C 39/068 |
| 10,981,650 B2 | Apr. 20, 2021 | Axel Fink, D | B64C 39/068 |
| | | | B64C 29/0025 |
| 10,994,829 B2 | May 4, 2021 | Michael J. | B64C 2201/108 |
| | | Duffy | B64C 2201/104 |
| | | | B64C 2201/024 |

### FOREING PATENT DOCUMENTS

EP3098161B1 May 24, 2016 Judas, Micheal B64C 29/00 BACKGROUND ON INVENTION

### 1. Field of the Invention

The disclosed invention relates to a VTOL (vertical take-off and landing) box-wing aerial vehicle, and more specifically to the configuration of the box-wing airframe with multiple rotors for VTOL flight and fixed push rotor for forward flight.

### 2. Discussion of the State of the Art

The helicopter is an essential modern air transportation vehicle. Technically, helicopter with rotary wing is also referred as “rotorcraft” or “rotary wing vehicle”. The rotary wing is commonly referred as “rotor”. Rotary wing positioned in the center of a shroud is called “ducted fan”. In general, rotary wing comprising of a plurality of blades rotating on the same axis. The rotary movement of the blades generates thrust by moving air. The rotary wing permits the helicopter to land and take-off vertically without the presence of a long run way. Disadvantageously, helicopter with fossil fuel engine is associated with expensive operational cost, undesirable high level of noise and carbon emission.

As the traffic is increasing heavy in the global urban area, an affordable electrical VTOL vehicle is a solution to avoid the congestion on the road. Without traffic delay, an electrical VTOL vehicle can also operate as law enforcement vehicle, ambulance and medical cargo transporter. A new term UAM (urban air mobility) is adopted for this new type of aerial transportation.

The arrival of distributed electrical propulsion system allows modern VTOL multirotor vehicle to substitute the traditional helicopter. The VTOL multirotor rotorcraft is advantageous for safety redundancy, in comparison to a single large rotor helicopter. The electrical propulsion system contains multiple independent smaller rotors to provide lift, propulsion and steering control. Quad-rotorcraft is a popular design for electrical multirotor vehicle, a simple design comprises of four moving rotors. The fixed pitch smaller rotor has low inertia, which allows the speed of the rotating blade to be decreased or increased rapidly. The modulation of the power setting on the rotors provides agile lift, propulsion and steering control. The disadvantage of the four rotors propulsion is that the rotor is smaller in diameter. Based on the momentum theory, small diameter rotor has low thrust lift efficient, due to the high disc loading.

Advantageously, modern electrical VTOL vehicle also has the capability to transition to airplane mode for forward flight. The energy required for VTOL flight is significantly higher than the energy required for a fix wing airplane flight to maintain forward flight. The VTOL vehicle can experience the following three types of flight mode: thrust borne, partial wing borne and wing borne. The vehicle is thrust borne in VTOL flight, which means the flight is made possible by vertical rotor thrust. Partial borne means the flight is made possible by the combination of vertical rotor thrust and wing lift. The vehicle is wing borne in airplane flight, which means the flight is made possible by lift generated by the wing. Furthermore, the forward propulsive movement in the airplane mode is generated by at least one push rotor. The main challenge of the transitional capability is the rapid hand over from thrust borne flight to wing borne flight. The desirable solution is to design the vehicle with partial wing borne flight capability between the transition of thrust borne flight to wing borne flight.

Traditional fixed wing aircraft suffers from significant loses of lift efficiency at the tip of the wings, due to the occurrence of vortex. As a result, winglet, sharklet and box-wing design is introduced to improve lift efficiency.

### BRIEF SUMMARY OF THE INVENTION

In one embodiment of the invention of a box-wing multirotor vehicle with both VTOL and airplane forward flight capability is provided, comprising a detachable cabin, a fuselage base having a longitudinal axis, fixed wings having a biplane arrangement, a pylon secured to the fixed wings at the tip, a pair of rudder, a pair of rotor boom, a pair of forward contra-rotating lift rotor, a pair of rear contra-rotating lift rotor, a main landing gear pad or wheel, a horizontal and vertical stabilizer, a push rotor, and a nose landing gear pad or wheel. Also in one embodiment the detachable cabin is separable from the box-wing multirotor vehicle for ground transportation.

In another embodiment of the invention of a box-wing multirotor vehicle with both VTOL and airplane forward flight capability is provided, comprising a detachable cabin, a fuselage base having a longitudinal axis, fixed wings having a biplane arrangement, a pylon secured to the fixed wings at the tip, a pair of rudder, a pair of rotor boom, pivotable rotor booms, a pair of forward lift rotor mounted on the rotor boom, a pair of forward lift rotor mounted on the pivotable rotor boom, a pair of rear lift rotor mounted on the rotor boom, a pair of rear lift rotor mounted on the pivotable rotor boom, a main landing gear pad or wheel, a horizontal and vertical stabilizer, a push rotor, and a nose landing gear pad or wheel.

### BRIEF DESCRIPTION OF THE DRAWINGS

Regarding the invention disclosure, the feature and advantage of the invention are particularly pointed and distinctly claimed in the claims. Detailed description and methods are given to provide further comprehension of the functionality of the invention. It should be observed that three mutual orthogonal directions X, Y, and Z are shown in some of the FIGURES. The first direction X is said to be “longitudinal”, and the forward side is referenced to be positive. Rotational movement around the longitudinal axis is said to be “roll”. The second direction Y is said to be “transverse”, and the port side is referenced to be positive. And the Y plane is referenced as centerline of the vehicle. Rotational movement around the transverse axis is said to be “pitch”. Finally, the third direction Z is said to be “vertical”, and the up side is referenced to be positive. Rotational movement around the vertical axis is said to be “yaw”. Furthermore, the direction of motion is shown in dash arrow and axis of rotation is shown in dot dash line.

FIG. 1 is a perspective view of a box-wing multirotor vehicle in according to an embodiment of the present invention.

FIG. 2 is a top plane view of the box-wing multirotor vehicle of FIG. 1.

FIG. 3 is a side view of the box-wing multirotor vehicle of FIG. 1.

FIG. 4 is a frontal view of the box-wing multirotor of FIG. 1.

FIG. 5 is a side view of the embodiment of the box-wing multirotor vehicle of FIG. 1 depicting the capability of separating the cabin from the fuselage base.

FIG. 6 is a perspective view of another box-wing multirotor vehicle in VTOL flight configuration.

FIG. 7 is a top plan view of the box-wing multirotor vehicle of FIG. 6.

FIG. 8 is a perspective view of box-wing multirotor vehicle of FIG. 6 in airplane flight configuration.

### DETAILED DESCRIPTION OF THE EMBODIMENTS

Advantageously, VTOL (vertical take-off and landing) vehicle can operate without a long runway. However, VTOL flight requires significantly higher energy than the energy required for a fixed wing aircraft to maintain forward flight. Therefore, the usefulness of VTOL vehicle is limited to short range flight. Modern VTOL is commonly designed with electrical power plant. In order to reduce the weight of electrical energy storage, an efficient VTOL vehicle can convert to airplane configuration for long range forward fight. In the disclosure of the invention, the technical term rotary wing is referred as “rotor”, and a rotary wing dedicated to generate lift is referred as “lift rotor”.

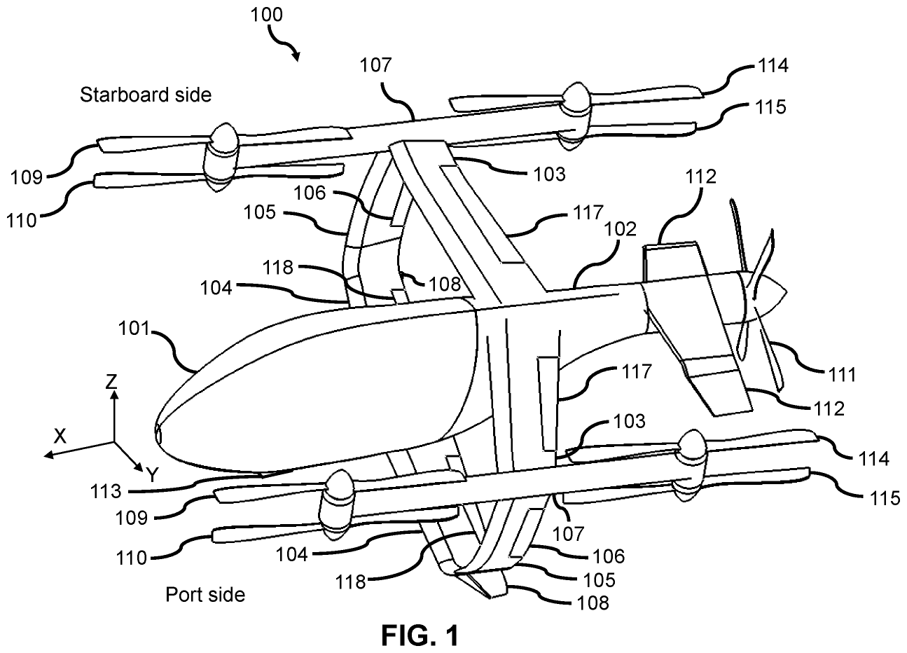

As shown in FIG. 1 to 4, the embodiment of box-wing multirotor 100. FIG. 1 shows a perspective view of the embodiment 100. The aerial vehicle is shown in the usual way, the fuselage of the box-wing multirotor vehicle 100 comprises of a detachable cabin 101 and the fuselage base 102. The upper portion of the fuselage base 102 is provided with upper wing 103 and the lower portion of the fuselage base 102 is provided with lower wing 104. The upper wing 103 is provided with elevator 117, and the lower wing 104 is provided with aileron 118. The upper wing 103 and lower wing 104 are joint at the tip by the pylon 105 to form the box-wing structure. The pylon 105 is provided with the heading control rudder 106. On the upper portion of the pylon 105 is provided with the rotor boom 107. On the lower portion of the pylon 105 is provided with the main landing gear pad 108. It can also be landing wheel. The forward portion of the rotor boom 107 is provided with the forward contra-rotating lift rotor, which comprises of the forward upper lift rotor 109 and forward lower lift rotor 110, and it may possibly be ducted fan. The rear portion of the rotor boom 107 is provided with the rear contra-rotating lift rotor, which comprises rear upper lift rotor 114 and rear lower lift rotor 115, and it may possibly be ducted fan. In the rear portion of the fuselage base 102 is provided with the horizontal and vertical stabilizer 112. At the tail portion of the fuselage base 102 is provided with the pusher rotor 111. At the nose portion of the fuselage base 102 is provided with nose landing gear pad 113. It can also be landing wheel.

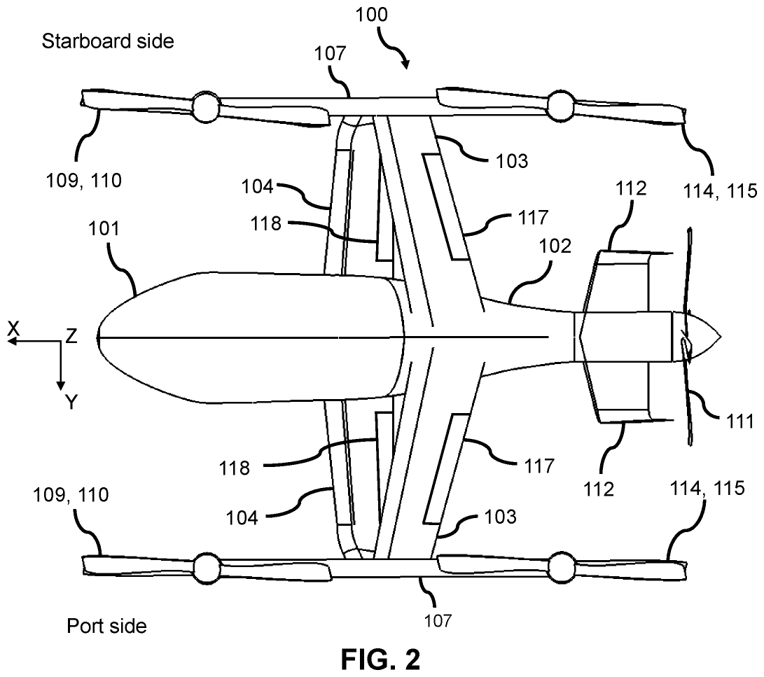

FIG. 2 shows the top plane view of the embodiment 100. The wings of the box-wing multirotor vehicle 100 comprises of the articulated upper wing 103 sweeps forward from the top portion of the fuselage base 102. The articulated lower wing 104 sweeps aftward from the lower portion of the fuselage base 102. The wing can also be dihedral or anhedral. The opposite sweeps of the upper wing 103 and lower wing 104 permits optimum advantages of uniform air flow around the two main wings.

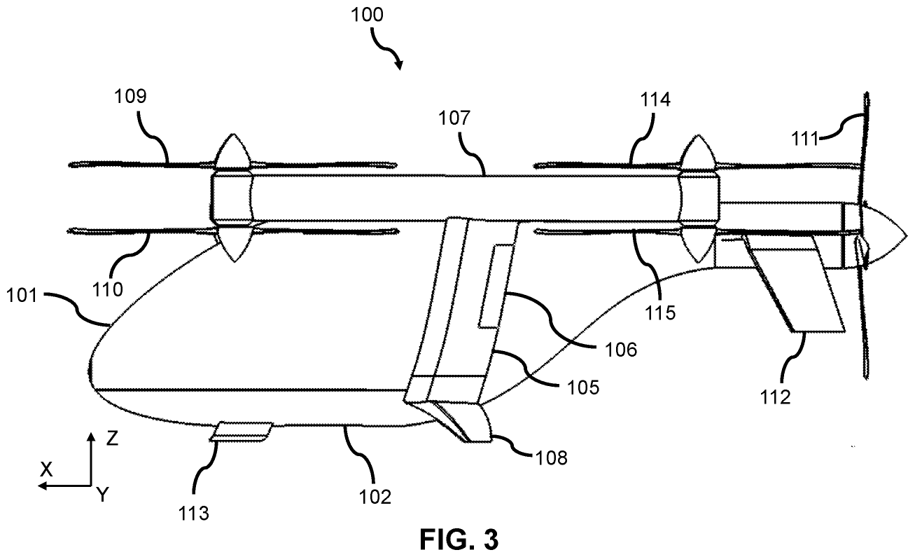

FIG. 3 shows a side view of the embodiment for clarity.

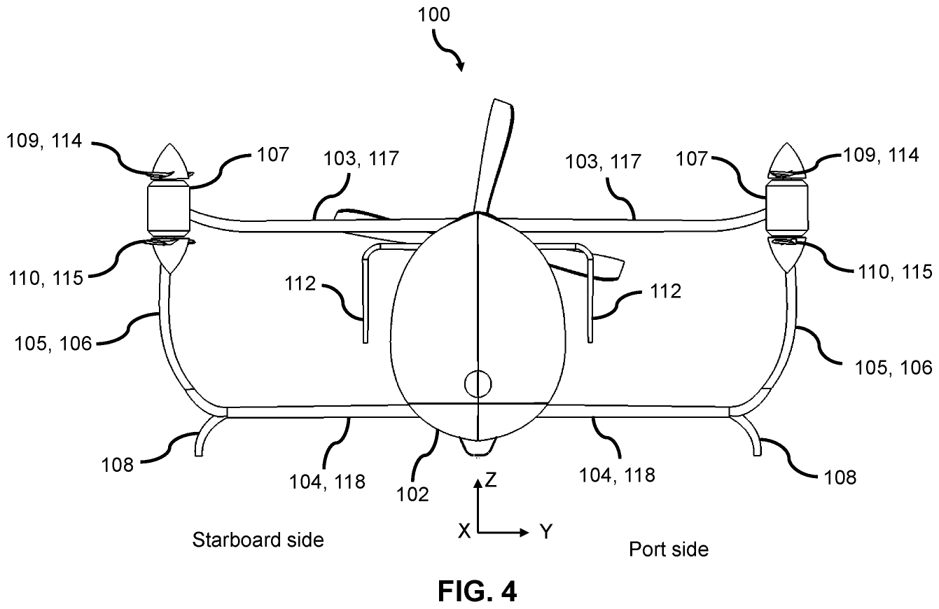

FIG. 4 shows the front view of the embodiment 100. It can be observed that the following components of the box-wing multirotor vehicle 100 are duplicated and symmetrical located on opposing sides of the Y plane. These components include the upper wing 103, lower wing 104, pylon 105, rudder 106, rotor boom 107, main landing gear pad 108, forward upper lift rotor 109, forward lower lift rotor 110, rear upper lift rotor 114, rear lower lift rotor 115, horizontal and vertical stabilizer 112, elevator 117 and aileron 118.

The operation of the box-wing multirotor vehicle 100 is described in the following sections. Advantageously, the box-wing multirotor vehicle 100 has four dedicated contra-rotating lift rotors to operate in VTOL flight (thrust borne flight). Naturally, the quad contra-rotating lift rotors provide the thrust vector during VTOL flight for taking-off, landing, hovering, and flying vertically. Moreover, the torque effect of the rotors assists the vehicle to change yaw heading. In order to transition from VTOL flight (thrust borne flight) to airplane flight (wing borne flight), the push rotor 111 propels the vehicle forward. Upon reaching a desired cruise speed, lift rotors 109, 110, 114 and 115 becomes unpowered. As a result, undisturbed air flow interacts with the wings 103 and 104 to generate airfoil lift. Finally, the flight is fully transition to airplane flight when the airborne lift force is fully provided by the wings 103 and 104. During airplane flight, the blade of the lift rotor 109, 110, 114 and 115 are stowed in parallel with the longitudinal axis to reduce aerodynamic drag. Furthermore, the rudder 106, elevator 117 and aileron 118 provide the flight control capability to steer the vehicle in the pitch, roll and yaw axis. Moreover, horizontal and vertical stabilizer 112 provides directional stability during airplane flight and might have hinged trim tabs to tune the heading, levelling, speed and attitude of the vehicle.

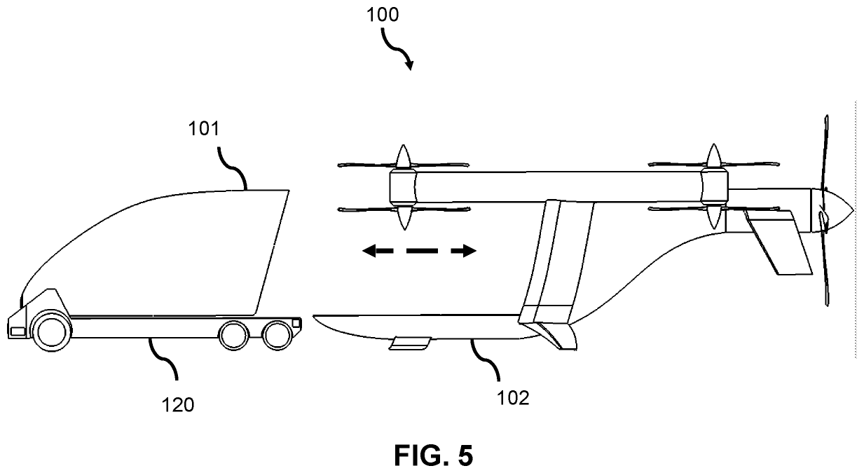

FIG. 5 illustrates the embodiment of the detachable cabin 101 separated from box-wing multirotor vehicle 100. Firstly, in one aspect, a rail system between the detachable cabin 101 and fuselage base 102 allows the detachable cabin 101 to slide out from fuselage base 102. Secondly, upon separating from the fuselage base 102, the detachable cabin 101 can be to be loaded on the flat bed of a specialized ground car 120. As a result, this feature allows the payload to be hauled to the final destination without being unloaded from the detachable cabin 101. Advantageously, it allows quick change of payload between flight. The multirole cabin can accommodate payload such as passenger, cargo, energy storage and airborne equipment, but not limited to the described payload.

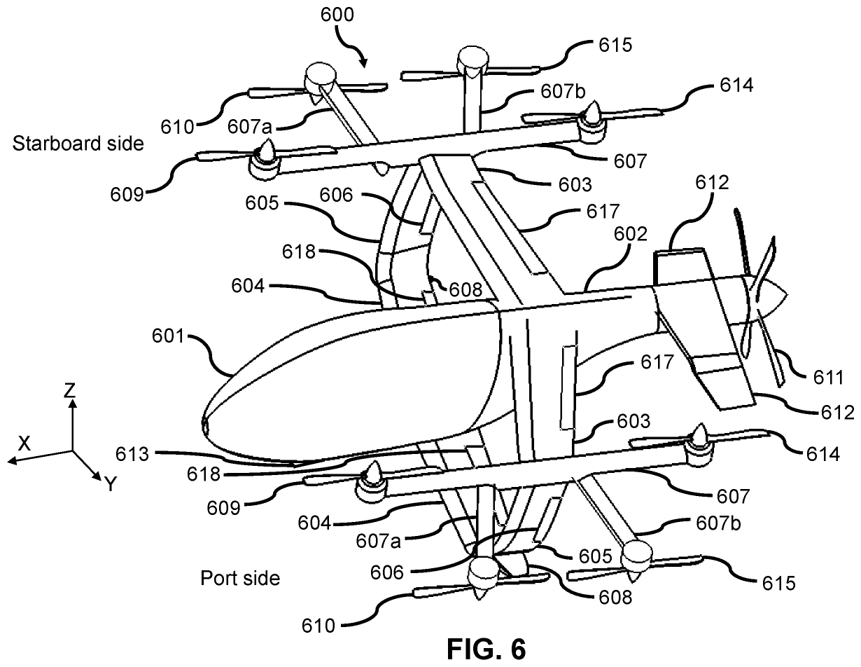

As shown in FIG. 6 to 8, the embodiment of box-wing multirotor 600. FIG. 6 shows a perspective view of the embodiment 600 in VTOL flight configuration. It can be observed that embodiment 600 comprises of the optional feature of pivotable rotor boom comparing to embodiment 100. The fuselage of the box-wing multirotor vehicle 600 comprises of a detachable cabin 601 and the fuselage base 602. The upper portion of the fuselage base 602 is provided with upper wing 603 and the lower portion of the fuselage base 602 is provided with lower wing 604. The upper wing 603 and lower wing 604 are joint at the tip by the pylon 605 to form the box-wing structure. The pylon 605 is provided with a heading control rudder 606. On the upper portion of the pylon 605 is provided with the rotor boom 607. On the lower portion of the pylon 605 is provided with the main landing gear pad 608. It can also be landing wheel. The forward portion of the rotor boom 607 is provided with the forward lift rotors, which comprise of the forward upper lift rotor 609 secured to the rotor boom 607 and forward lower lift rotor 610 secured to the forward pivotable rotor boom 607a. It can also be ducted fan. The rear portion of the rotor boom 607 is provided with the rear lift rotors, which comprise of the rear upper lift rotor 614 secured to the rotor boom 607 and rear lower lift rotor 615 secured to the rear pivotable rotor boom 607b. It can also be ducted fan. The forward pivotable rotor boom 607a and rear pivotable rotor boom 607b are shown in the deployed position. The rear portion of the fuselage base 602 is provided with the horizontal and vertical stabilizer 612. At the tail portion of the fuselage base 602 is provided with the pusher rotor 611. At the nose portion of the fuselage base 602 is provided with nose landing gear pad 613. It can also be landing wheel.

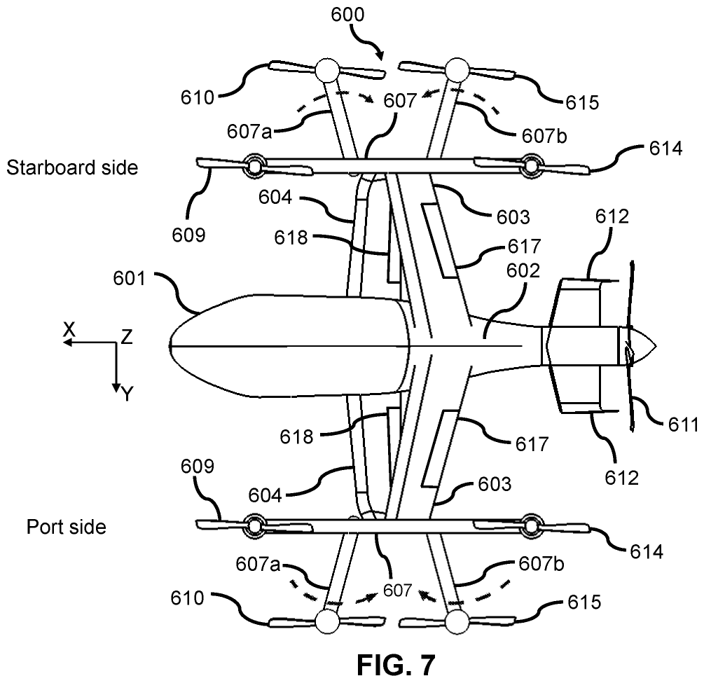

FIG. 7 shows the top plane view of the embodiment 600. The dash arrows show the direction of motion of the forward pivotable rotor boom 607a and rear pivotable rotor boom 607b from stowed to deployed position.

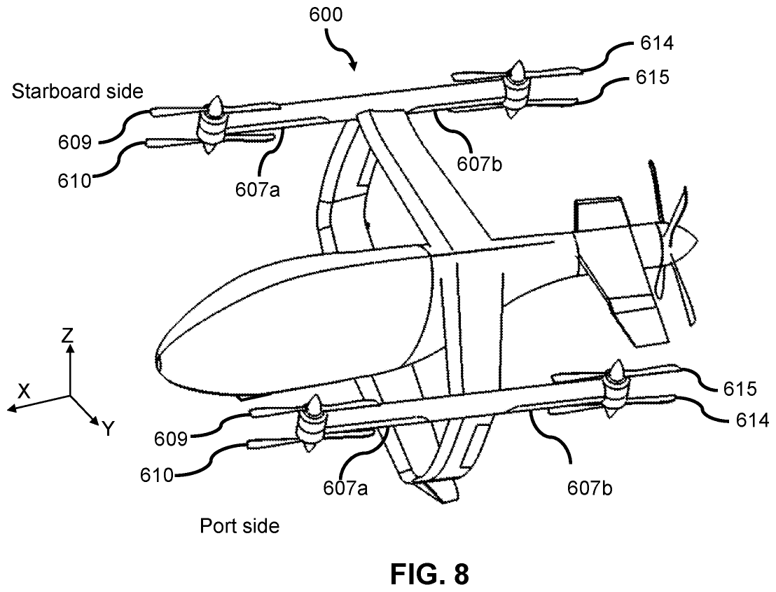

FIG. 8 shows a perspective view of the embodiment 600 in airplane flight configuration. It can be observed that forward pivotable rotor boom 607a and rear pivotable rotor boom 607b are shown in the stowed position.

The VTOL flight (thrust borne flight) of the box-wing multirotor vehicle 600 is described in the following sections. As shown in FIG. 6, the box-wing multirotor vehicle 600 has eight dedicated lift rotors to operate in VTOL flight. Naturally, the eight lift rotors inherited higher propulsion efficiency and lower rotor noise due to the reduction of rotor speed. The eight lift rotors provide the thrust vector to operate during VTOL flight for taking-off, landing, hovering, and flying vertically. Moreover, the torque effect of the rotors assists the vehicle to change yaw heading.

The transitional flight from VTOL flight (thrust borne flight) to airplane flight (wing borne flight) of the box-wing multirotor vehicle 600 is described in the following section. Firstly, the push rotor 611 is powered to propel the vehicle forward. Secondly, at given forward speed, lift rotors 609 and 614 become unpowered, and stowed in parallel with the longitudinal axis of the fuselage to reduce aerodynamic drag. Consequently, undisturbed air flow interacts with the wing 603 and 604 to generate airfoil lift. As a result, the sum of airborne lift force is contributed by the wings 603, 604 and lift rotors 610, 615. The vehicle is known to be in partial wing borne flight. Consequently, wing lift force increases and lift rotor lift decreases, as the forward speed accelerates to the desired cruise speed. Finally, upon reaching the desired cruise speed, the flight is fully transition to airplane flight when all the airborne lift force is provided by the wings 603, 604. Moreover, lift rotors 610 and 615 become unpowered and the blade of the lift rotors 610 and 615 are stowed in parallel with the longitudinal axis to reduce aerodynamic drag. During cruise, the forward pivotable rotor boom 607a and rear pivotable rotor boom 607b retract to the stowed position as shown in FIG. 8. In airplane flight, the rudder 606, elevator 617 and aileron 618 provide the flight control capability to steer the vehicle in the pitch, roll and yaw axis. Finally, horizontal and vertical stabilizer 612 provides directional stability during airplane flight and might have hinged trim tabs to tune the heading, levelling, speed and attitude of the vehicle. Naturally, box-wing multirotor vehicle 600 can also operating in VTOL flight mode in the configuration shown in FIG. 8.

Naturally, there are numerous variations, modifications and configurations which may be made hereto without departing from the scope of the disclosure invention. It should be understood that the embodiments are for illustrative and explanatory purpose and it is not conceivable to identify exhaustively all possible embodiments. In particular, it is important to observe that the invention as described relates in particular to an aerial multirotor vehicle with specific positioning of lift rotors secured to the box-wing. The design of the box-wing benefits from an improvement of structural strength, fatigue strength and load carrying strength. The box-wing permits the lift rotors to be secured to the upper portion of the vehicle, which prevents the rotating blade from striking a person or object near the ground. Finally, the box-wing with a plurality of main wings design permits the wing span to be reduced in the transverse direction. Nevertheless, the invention is applicable to any multirotor vehicle of arbitrary weight, such as a light drone to a large tonnage vehicle.

What is claimed is:

1. A box-wing multirotor aerial vehicle adapted for VTOL comprising:
a detachable cabin;
a fuselage base, said fuselage base comprising:
a nose portion; a lower portion; an upper portion; a rear portion; and a tail portion;
a fixed box-wing, said fixed box wing comprising:
a port side fixed box-wing section, said port side fixed wing comprising:
a stagger biplane arrangement consisting of the transversally extended port side upper wing secured to said upper portion of said fuselage base; and the transversally extended port side lower wing secured to said lower portion of said fuselage base; wherein said port side upper wing and said port side lower wing are spaced apart longitudinally and vertically; wherein said port side upper wing and said port side lower wing have an articulated swept on the vertical or horizontal direction; wherein said port side upper wing and said port side lower wing are joint at the tip by the port side pylon;
a starboard side fixed box-wing section, said starboard side fixed wing comprising:
a stagger biplane arrangement consisting of the transversally extended starboard side upper wing secured to said upper portion of said fuselage base; and the transversally extended starboard side lower wing secured to said lower portion of said fuselage base; wherein said starboard side upper wing and said starboard side lower wing are spaced apart longitudinally and vertically; wherein said starboard side upper wing and said starboard side lower wing have an articulated swept on the vertical or horizontal direction; wherein said starboard side upper wing and said starboard side lower wing are joint at the tip by the starboard side pylon;
a port side rudder is disposed on said port side pylon;
a starboard side rudder is disposed on said starboard side pylon;
a port side elevator is disposed on said port side upper wing;
a starboard side elevator is disposed on said starboard side upper wing;
a port side aileron is disposed on said port side lower wing;
a starboard side aileron is disposed on said starboard side lower wing;
a port side rotor boom, said port side rotor boom comprising:
a middle portion secured to at least one or more of said port side upper wing, said port side lower wing, and said port side pylon;
a forward portion is mounted with the port side forward contra-rotating lift rotor;
a rear portion is mounted with the port side rear contra-rotating lift rotor;
a starboard side rotor boom, said starboard side rotor boom comprising:
a middle portion secured to at least one or more of said starboard side upper wing, said starboard side lower wing, and said starboard side pylon;
a forward portion is mounted with the starboard side forward contra-rotating lift rotor;
a rear portion is mounted with the starboard side rear contra-rotating lift rotor;
a port side main landing gear pad and wheel secured to said port side pylon;
a starboard main landing gear pad and wheel secured to said starboard side pylon;
a horizontal and vertical stabilizer respectively secured on opposing sides of said rear portion of said fuselage base;
a push rotor secured to said tail portion of said fuselage base;
a landing gear pad and wheel secured to said nose portion of said fuselage base.

2. A box-wing multirotor vehicle as set forth in claim 1, wherein said detachable cabin is separable from said box-wing multirotor vehicle by sliding on an integrated rail system to be loaded on a ground transportation device.

3. A box-wing multirotor vehicle as set forth in claim 1, wherein the detachable cabin having the usage to hold passenger, cargo, equipment and energy storage.

4. A box-wing multirotor vehicle as set forth in claim 1, wherein said port side forward contra-rotating lift rotor, said starboard side contra-rotating lift rotor, said port side rear contra-rotating lift rotor, and said starboard side rear contra-rotating lift rotor provide the thrust vector for taking-off, landing, hovering and flying vertically lift, and yaw heading torque effect.

5. A box-wing multirotor vehicle as set forth in claim 1, wherein said push rotor provides the forward propulsion during airplane flight.

6. A box-wing multirotor vehicle as set forth in claim 1, wherein said fixed box-wing provides airborne lift during airplane flight.

7. A box-wing multirotor vehicle as set forth in claim 1, wherein said rudders, elevators and ailerons provide pitch, roll and yaw control during airplane flight.

8. A box-wing multirotor vehicle as set forth in claim 1, wherein said horizontal and vertical stabilizer comprising of at least one or more fixed horizontal airfoil, fixed vertical airfoil, fixed diagonal airfoil and hinged trim tab.

9. A box-wing multirotor aerial vehicle adapted for VTOL comprising:
a detachable cabin;
a fuselage base, said fuselage base comprising:
a nose portion; a lower portion; an upper portion; a rear portion; and a tail portion;
a fixed box-wing, said fixed box wing comprising:
a port side fixed box-wing section, said port side fixed wing comprising:
a stagger biplane arrangement consisting of the transversally extended port side upper wing secured to said upper portion of said fuselage base; and the transversally extended port side lower wing secured to said lower portion of said fuselage base; wherein said port side upper wing and said port side lower wing are spaced apart longitudinally and vertically; wherein said port side upper wing and said port side lower wing have an articulated swept on the vertical or horizontal direction; wherein said port side upper wing and said port side lower wing are joint at the tip by the port side pylon;
a starboard side fixed box-wing section, said starboard side fixed wing comprising:
a stagger biplane arrangement consisting of the transversally extended starboard side upper wing secured to said upper portion of said fuselage base; and the transversally extended starboard side lower wing secured to said lower portion of said fuselage base; wherein said starboard side upper wing and said starboard side lower wing are spaced apart longitudinally and vertically; wherein said starboard side upper wing and said starboard side lower wing have an articulated swept on the vertical or horizontal direction; wherein said starboard side upper wing and said starboard side lower wing are joint at the tip by the starboard side pylon;
a port side rudder is disposed on said port side pylon;
a starboard side rudder is disposed on said starboard side pylon;
a port side elevator is disposed on said port side upper wing;
a starboard side elevator is disposed on said starboard side upper wing;
a port side aileron is disposed on said port side lower wing;
a starboard side aileron is disposed on said starboard side lower wing;
a port side rotor boom, said port side rotor boom comprising:
a middle portion secured to at least one or more of said port side upper wing, said port side lower wing, and said port side pylon;
a forward portion is mounted with the first port side forward lift rotor;
a rear portion is mounted with the first port side rear lift rotor;
a forward pivotable portion is mounted with the second port side forward lift rotor;
a rear pivotable portion is mounted with the second port side rear lift rotor;
a starboard side rotor boom, said starboard side rotor boom comprising:
a middle portion secured to at least one or more of said starboard side upper wing, said starboard side lower wing, and said starboard side pylon;
a forward portion is mounted with the first starboard side forward lift rotor;
a rear portion is mounted with the first starboard side rear lift rotor;
a forward pivotable portion is mounted with the second starboard side forward lift rotor;
a rear pivotable portion is mounted with the second starboard side rear lift rotor;
a port side main landing gear pad and wheel secured to said port side pylon;
a starboard main landing gear pad and wheel secured to said starboard side pylon;
a horizontal and vertical stabilizer respectively secured on opposing sides of said rear portion of said fuselage base;
a push rotor secured to said tail portion of said fuselage base;
a landing gear pad and wheel secured to said nose portion of said fuselage base.

10. A box-wing multirotor vehicle as set forth in claim 9, wherein said detachable cabin is separable from said box-wing multirotor vehicle by sliding on an integrated rail system to be loaded on a ground transportation device.

11. A box-wing multirotor vehicle as set forth in claim 9, wherein the detachable cabin having the usage to hold passenger, cargo, equipment and energy storage.

12. A box-wing multirotor vehicle as set forth in claim 9, wherein said first port side forward lift rotor, said first starboard side forward lift rotor, said first port side rear lift rotor, said first starboard side rear lift rotor, wherein said second port side forward lift rotor, said second starboard side forward lift rotor, said second port side rear lift rotor, and said second starboard side rear lift rotor provide the thrust vector for taking-off, landing, hovering and flying vertically lift, and yaw heading torque effect.

13. A box-wing multirotor vehicle as set forth in claim 9, wherein said push rotor provides the forward propulsion during airplane flight.

14. A box-wing multirotor vehicle as set forth in claim 9, wherein said fixed box-wing provides airborne lift during airplane flight.

15. A box-wing multirotor vehicle as set forth in claim 9, wherein said rudders, elevators and ailerons provide pitch, roll and yaw control during airplane flight.

16. A box-wing multirotor vehicle as set forth in claim 9, wherein said horizontal and vertical stabilizer comprising of at least one or more fixed horizontal airfoil, fixed vertical airfoil, fixed diagonal airfoil and hinged trim tab.
